(19) United States
(12) Patent Application Publication
(10) Pub. No.: US 2025/0321769 A1
(43) Pub. Date: Oct. 16, 2025

(54) PROVISION OF TAILORED INSTRUCTION SET

(71) Applicant: Lenovo Global Technology (United States) Inc., Morrisville, NC (US)

(72) Inventors: Mark Christopher Heidenfeldt, Apex, NC (US); Justin Ringuette, Cary, NC (US); Rashidul S. Islam, Cary, NC (US)

(21) Appl. No.: 18/636,997

(22) Filed: Apr. 16, 2024

(51) Int. Cl. G06F 9/451; G06F 3/0484

(52) U.S. Cl. CPC G06F 9/453; G06F 3/0484

(57) ABSTRACT

One embodiment provides a method, the method including: identifying, using a task guidance system, a task to be performed by a user; determining, using the task guidance system, a skill level of the user with respect to the task, wherein the determining includes accessing a profile of the user identifying a plurality of tasks and a skill level of the user for each of the plurality of tasks; and providing, to the user and using the task guidance system, an instruction set for performing the task, wherein a level of detail within the instruction set provided is based upon the skill level of the user. Other aspects are claimed and described.

### BACKGROUND

To assist in performing tasks, users may reference instructions sets (e.g., videos, manuals, instruction guides, tips, etc.) that provide steps of the task and details on how to perform steps within the task. The instruction set may break the task into different steps and then provide instructions on how to perform each step. Depending on the audience, the instruction sets may have more or less details, including pictures, helpful tips, and/or the like, for each of the steps. Additionally, the instruction set may have more or fewer steps based upon the audience. For example, an instruction set for a technician familiar with a system or device associated with the instruction set may have less details than an instruction set for an end user. The instruction set can then be provided in a medium that allows the user performing the step to reference the instruction set while performing the task. For example, the instruction set may be provided as a video, paper guide, as instructions on a display screen, as audible output, and/or the like. Each of the different mediums may allow for different user interaction with the instruction set.

### BRIEF SUMMARY

In summary, one aspect provides a method, the method including: identifying, using a task guidance system, a task to be performed by a user; determining, using the task guidance system, a skill level of the user with respect to the task, wherein the determining includes accessing a profile of the user identifying a plurality of tasks and a skill level of the user for each of the plurality of tasks; and providing, to the user and using the task guidance system, an instruction set for performing the task, wherein a level of detail within the instruction set provided is based upon the skill level of the user.

Another aspect provides a system, the system including: a processor; a memory device that stores instructions that, when executed by the processor, causes the system to: identify, using a task guidance system, a task to be performed by a user; determine, using the task guidance system, a skill level of the user with respect to the task, wherein the determining includes accessing a profile of the user identifying a plurality of tasks and a skill level of the user for each of the plurality of tasks; and provide, to the user and using the task guidance system, an instruction set for performing the task, wherein a level of detail within the instruction set provided is based upon the skill level of the user.

A further aspect provides a product, the product including: a computer-readable storage device that stores executable code that, when executed by a processor, causes the product to: identify, using a task guidance system, a task to be performed by a user; determine, using the task guidance system, a skill level of the user with respect to the task, wherein the determining includes accessing a profile of the user identifying a plurality of tasks and a skill level of the user for each of the plurality of tasks; and provide, to the user and using the task guidance system, an instruction set for performing the task, wherein a level of detail within the instruction set provided is based upon the skill level of the user.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for providing an instruction set to a user for performance of a task, where the instruction set is modified and tailored to an identified skill level of the user.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Even though instruction sets may be developed for different audience groups, each member of the audience group receives the same instruction set. In other words, there is no distinguishment between skills sets of different members of an audience. Instead, the instruction sets are generally developed based upon a least skilled member of an audience. For example, an instruction set that is developed for an end user audience may include a large number of details so that the least skilled member of the end user audience who may be wanting to perform the task can utilize the instruction set and successfully perform the task. Similarly, an instruction set developed for a technician audience is developed assuming the technician referencing the instruction set has the least experience in performing the task.

What ends up happening is a skilled member of the audience for whom the instruction set was developed ignores or skips reading or referring to many of the steps within the instruction set. In other words, while the skilled member performs the steps to accomplish the task, the skilled member does not refer to the instruction set when performing the steps. However, particularly in a technician or service environment, there may be requirements to acknowledge the performance of steps within the instruction set. Additionally, in some cases, there may be time limits placed on how frequently a user can acknowledge that the steps were performed. Thus, the user may have to take the time to acknowledge each step within the instruction set, even if the user did not refer to the instruction set to perform the step, and the user may be forced to wait to acknowledge a next step until the time limit has expired. This results in an inefficient performance of the actual task due to having to interface with the instruction set. Additionally, because the user is not actually referring to the instruction set, the user may inadvertently skip a step, incorrectly perform a step, and/or the like. Thus, the conventional systems result in inefficient and ineffective performance of the task.

Accordingly, the described system and method provides a technique for providing an instruction set to a user for performance of a task, where the instruction set is modified and tailored to an identified skill level of the user. The task guidance system identifies a task to be performed by a user. In identifying the task, the task guidance system may receive user input identifying the task to be performed, may monitor the user and identify or infer the task that the user is about to perform, may access a secondary source that identifies tasks to be performed by the user, and/or the like.

Upon identification of the task to be performed by the user, the task guidance system determines a skill level of the user with respect to the task. In other words, the task guidance system determines how skilled the user is with respect to the task. The skill level may be saved within a user profile for the user, so the task guidance system may access the user profile to determine the skill level of the user. A user may provide input that is used to determine the skill level. For example, the user may identify how many times they have performed a particular task, may identify trainings that were performed for a particular task, and/or the like. The system may also monitor the user and automatically adjust the skill level as the user performs different tasks. The task guidance system may also be able to infer skill levels for particular tasks based upon similarities of the task to other tasks, a comfort level of the user when performing at task, and/or the like.

Based upon the skill level, the task guidance system provides an instruction set to the user for performing the task. However, instead of a standard or default instruction set, the system modifies or adjusts the instruction set to be based upon the skill level of the user. In other words, a level of detail within the instruction set is based upon the skill level of the user. Accordingly, a user with a high skill level with respect to a particular task will be presented with an instruction set having less details than a user with a lower skill level. Provision of the modified instruction set may be using any output modality, including, but not limited to, as a visual output on a display device, as audible output on a speaker, as haptic output on a haptic device, a combination thereof, and/or the like. The device may also be any type of information handling device, including, but not limited to, a personal computer, an augmented reality device and/or headset, a virtual reality device and/or headset, a portable information handling device (e.g., smartphone, smart watch, laptop computer, etc.), a television, a smart television, a haptic device, a speaker, a combination thereof, and/or the like.

Therefore, a system provides a technical improvement over traditional methods for provision of instruction sets. Instead of providing an instruction set that is the same for every user that may be utilizing the instruction set, the described system is able to provide an instruction set that is unique to the user who is performing the task. In other words, the described system modifies and adjusts the instruction set to provide details needed by the user, instead of providing all possible details that may be needed for users of all skill levels. Since the instruction set is provided based upon the skill level of the user, it can reduce errors performed by users that may be caused by users ignoring the instruction set due to details being unnecessarily provided to a user. Additionally, in some cases, the system is able to monitor performance of the task by a user and provide direct feedback to the user if a step is being improperly performed. Thus, the described system and method provides an instruction set that results in a more efficient performance of the task and acknowledgement of task steps, if that is a part of the task performance process. Additionally, the modified instruction set can prevent errors, thereby providing a technique to make performance of a task more accurate.

The illustrated example embodiments will be best understood by reference to the figures. The following description is intended only by way of example, and simply illustrates certain example embodiments.

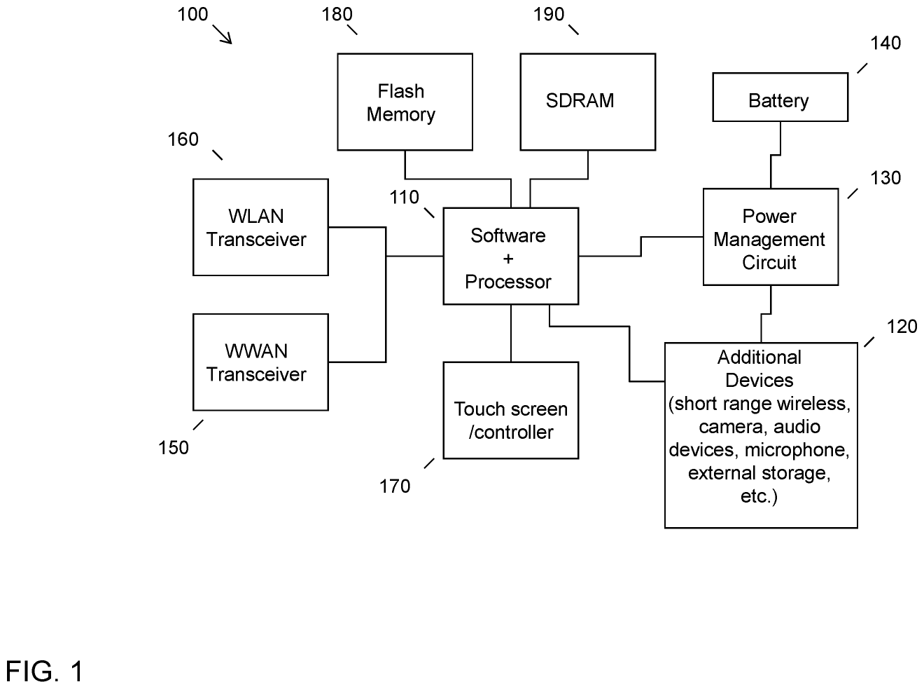

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks, such as telecommunications networks and wireless Internet devices, e.g., access points. Additionally, devices 120 are commonly included, e.g., a wireless communication device, external storage, etc. System 100 often includes a touch screen 170 for data input and display/rendering. System 100 also typically includes various memory devices, for example flash memory 180 and synchronous dynamic random-access memory (SDRAM) 190.

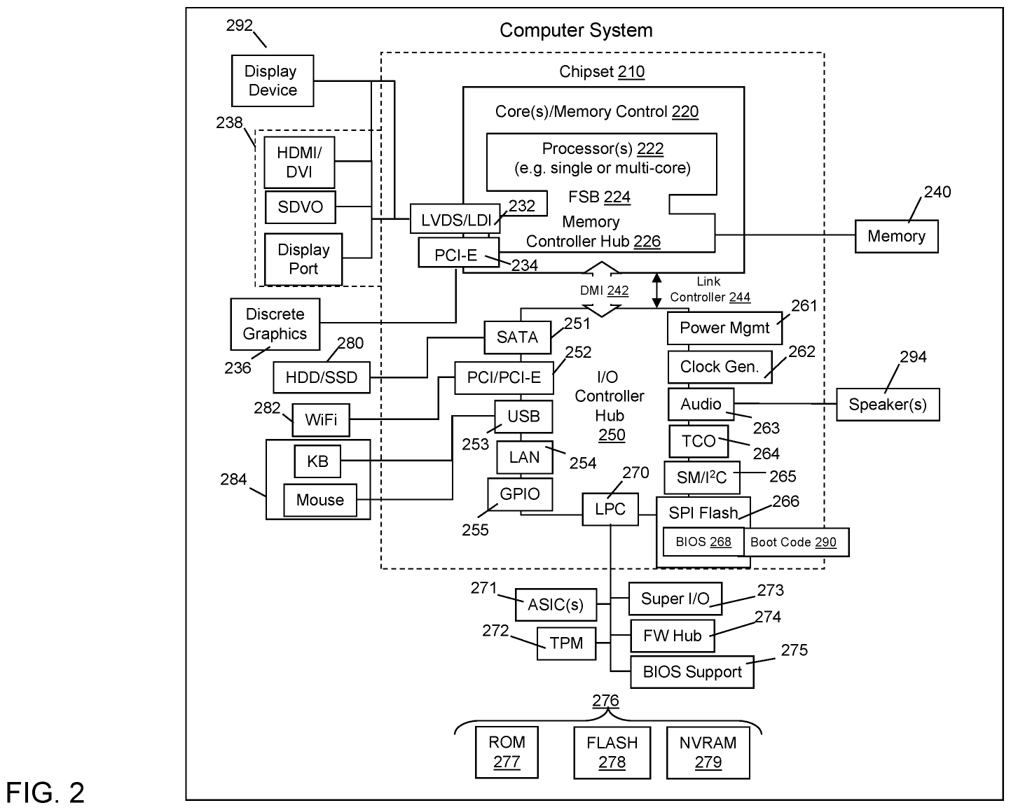

FIG. 2 depicts a block diagram of another example of information handling device circuits, circuitry, or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may be used in devices or systems associated with servers and networks to which servers may be added or provisioned and devices or systems that may assist in identifying servers to be provisioned and provisioning the servers. For example, the circuitry outlined in FIG. 1 may be implemented in a tablet or smart phone embodiment, whereas the circuitry outlined in FIG. 2 may be implemented in a personal computer embodiment.

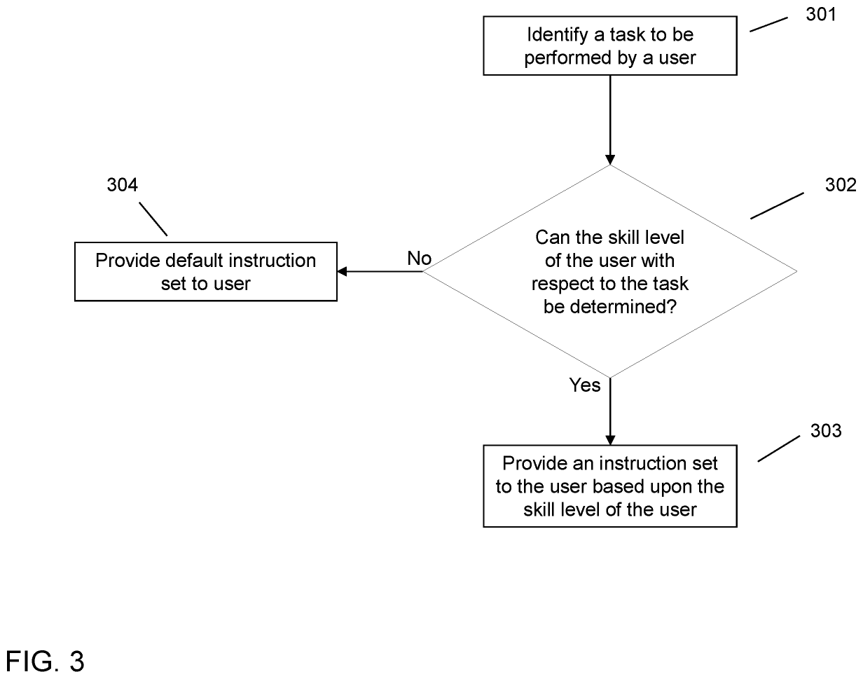

FIG. 3 illustrates an example method for providing an instruction set to a user for performance of a task, where the instruction set is modified and tailored to an identified skill level of the user. The method may be implemented on a system which includes a processor, memory device, output devices (e.g., display device, printer, etc.), input devices (e.g., keyboard, touch screen, mouse, microphones, sensors, biometric scanners, etc.), image capture devices, and/or other components, for example, those discussed in connection with FIG. 1 and/or FIG. 2. While the system may include known hardware and software components and/or hardware and software components developed in the future, the system itself is specifically programmed to perform the functions as described herein to provide a tailored instruction set to a user for performance of a task. Additionally, the task guidance system includes modules and features that are unique to the described system.

The activation of the task guidance system may be manual, where a user provides an input indicating that the task guidance system should be activated, or automatic where the task guidance system detects a trigger event indicating that the system should be activated. Example trigger events include detection of a user or technician at a workstation or location where instruction sets are normally displayed, activation of software or an application utilizing the task guidance system (e.g., instruction set provision application, task queue application, etc.), activation of a device that is utilized for provision of instruction sets, and/or the like. For example, the system may detect that a technician whose job is to service devices is currently located at the workbench or location where the device servicing occurs, identify this as a trigger event, and may thereafter activate the task guidance system. As another example, a user may have a device that is specifically used in providing instructions sets or assisting in performing a task and an activation of this device may activate the task guidance system, even if the task guidance system is located on or displayed on another device.

The task guidance system may be a standalone system, may be accessible through other computing devices, and/or a combination thereof. For example, the task guidance system may be a standalone system that can be accessed by a user and/or may be or provide an application that is accessible by a user on another computing device. The task guidance system may be accessible using any type of computing device, for example, personal computer, laptop computer, smartphone, tablet, smartwatch, head-mounted display, smart television or other smart appliance, augmented reality device, virtual reality device, and/or the like. Thus, the task guidance system may be accessible locally using a computing device where the task guidance system is installed and/or may be accessible remotely through another computing device. For example, the task guidance system may be accessed by a service technician using a device that communicates with the task guidance system to access and/or display task instruction sets. However, the task guidance system may be located and operate on a different information handling device to perform the described steps.

The task guidance system may have an associated graphical user interface. The graphical user interface may be provided on a display or monitor, which may or may not be associated with the task guidance system. In other words, the task guidance system may have a dedicated display or monitor or may be accessible using any display or monitor. In either case, the task guidance system may provide instructions to generate and display the graphical user interface on the display device being used to access the task guidance system. The graphical user interface may also be updated and managed based upon instructions provided by the task guidance system. In other words, the task guidance system generates and transmits instructions to create and update the graphical user interface.

The graphical user interface may include a plurality of tabs, windows, and/or unique interfaces. The graphical user interface may include graphical user interface icons or elements. Graphical user interface icons or elements may include static non-selectable elements (e.g., headers, footers, logos, global information areas, graphics, etc.), dynamic non-selectable elements (e.g., local information areas applying to a specific element, dynamic graphics, information areas that update based upon the information provided therein, indicators, statistics displays, etc.), static selectable elements (e.g., radio buttons, menu icons, selectable indicators, etc.), dynamic selectable elements (e.g., form field input areas, pull-down menus, pop-up windows, etc.), and/or any other elements that may be found in a graphical user interface.

The graphical user interface may allow a user to provide input identifying information to be used by the task guidance system. For example, the task guidance system may utilize a user profile to identify a skill level of the user. The graphical user interface may allow for creation of this user profile by allowing a user to input information regarding the user, tasks, trainings, and/or the like. As will be discussed in more detail, the use of user provided information is not the only way that the user profile can be created. The task guidance system can then utilize these inputs to create the user profile. A user could also use the graphical user interface to adjust information within the user profile. A user may also use the graphical user interface to add task information, adjust task information, identify tasks that need instruction sets, provide or create an initial instruction set for a task, identify audiences for a particular instruction set, and/or the like. Additionally, or alternatively, the user can input a location of information related to a user profile or task, provide a file corresponding to information related to a user profile and/or task, and/or the like, within the graphical user interface. Input may be provided by the user using any type of input modality, including, but not limited to, mechanical input (e.g., keyboard input, mouse input, etc.), touch input, audible or voice input, gesture input, haptic input, and/or the like.

The graphical user interface may also provide displays that display information of the user profiles, tasks, instructions sets, and/or the like. It should be noted that the information to be used by the task guidance system and information provided by the task guidance system can be different for different applications, different computing systems, different users, and/or the like. Thus, the information corresponding to input or output of the task guidance system are not always the same. However, the task guidance system may have default or system-wide settings that are the same across different users, systems, applications, and/or the like, until the information is adjusted or otherwise changed.

It should be noted that different users may configure the graphical user interface per their preferences. Thus, the graphical user interface layout and configuration may be different between users. How much a user can configure the layout may be restricted or set by a system administrator and/or the like. Additionally, different users or different user roles may have different levels of access, which may also change how and what information is displayed. Thus, different graphical user interfaces may be displayed by the system.

The task guidance system may utilize one or more artificial intelligence models in identifying tasks to be performed by users, creating and modifying user profiles, determining a skill level of a user, and determining how instructions sets should be modified based upon a determined skill set. Artificial intelligence models may also be used for steps within a step. For example, a model could be utilized to identify similarities between tasks when determining a skill level of a user, to determine what a user is doing or holding when identifying a task, and/or the like. For ease of readability, the majority of the description will refer to a single artificial intelligence model. However, it should be noted that an ensemble of artificial intelligence models or multiple artificial intelligence models may be utilized. Additionally, the term artificial intelligence model within this application encompasses neural networks, machine-learning models, deep learning models, artificial intelligence models or systems, and/or any other type of computer learning algorithm or artificial intelligence model that may be currently utilized or created in the future.

The artificial intelligence model may be a pre-trained model that is fine-tuned for the task guidance system or may be a model that is created from scratch. Since the task guidance system is used in conjunction with identifying tasks to be performed, determining a skill level of a user, and creating or modifying an instruction set based upon the determined skill level, some models that may be utilized by the system are text analysis models, image analysis models, similarity identification models, large language models, filtering models, classification models, and/or the like. The model may be trained using one or more training datasets. Additionally, as the model is deployed, it may receive feedback to become more accurate over time. The feedback may be automatically ingested by the model as it is deployed. For example, as the model is used to identify a task to be performed by a user, determine a skill level of the user, and/or create an instruction set based upon a skill level of the user, if a user or technician modifies identification of the task to be performed, modifies a user profile, provides feedback regarding a provided instructions set, or otherwise provides some indication that the predictions or selections made by the model may be incorrect, the model ingests this feedback to refine the model.

On the other hand, as the model identifies tasks, determines skill levels of users, creates and provides instructions sets to users, and/or the like, and no changes are made to the identified task, determined skill level, provided instruction set, and/or the like, the model may utilize this as feedback to further refine the model. This may be referred to as reinforcement training where a prediction that was made by the model is reinforced as the correct prediction. Training the model may be performed in one of any number of ways including, but not limited to, supervised learning, unsupervised learning, semi-supervised learning, training/validation/testing learning, and/or the like.

As previously mentioned, an ensemble of models or multiple models may also be utilized. Some example models that may be utilized are variational autoencoders, generative adversarial networks, recurrent neural network, convolutional neural network, deep neural network, autoencoders, random forest, decision tree, gradient boosting machine, extreme gradient boosting, multimodal machine learning, unsupervised learning models, deep learning models, transformer models, inference models, and/or the like, including models that may be developed in the future. The chosen model structure may be dependent on the particular task that will be performed with that model.

The task guidance system may include different components for carrying out different functions of the system, including different steps to be performed. These components may be hardware components or software components. Some hardware components may include sensors (e.g., biometric sensors, image capture devices, proximity sensors, microphones, accelerometers, etc.) that can be used to identify a user, identify a task that is being performed by the user, identify when the user is in proximity to a task area, monitor performance of a task by the user, identify gestures provided by a user, capture audio provided by the user, and/or the like. Other input devices may be utilized to receive input from the user, for example, mechanical input modalities (e.g., keyboard, mouse, etc.), touch input devices, gesture input devices, electromyography input devices, audio input devices, and/or the like. Other hardware components may be utilized to provide output from the task guidance system. For example, the task guidance system may include speakers, displays or monitors, haptic output devices, audio output devices, and/or the like.

One software component is the user profile. The user profile is unique to each user. If a user does not have a user profile, a default user profile can be compiled for the user and then modified as the user provides input and the system learns information about the user. For example, if a new user accesses the task guidance system, a default user profile may be populated for the user. The default user profile may have default skill levels for different tasks set at the lowest skill level. In other words, the user would be presumed to have no previous skill in any particular task and task guidance system would present the most detailed instruction sets to the user. The user profile can be updated, either for new or previous users, based upon different input.

One type of input may be input that is provided by the user. For example, the user may be presented with a survey or form where the user can provide input identifying different skill levels, different familiarity with different devices, tasks, systems, and/or the like, different trainings the user has performed, a work history, and/or any other information that may be useful in identifying a skill level of the user. The user may also provide feedback regarding performance of the task and update the profile of the user based on the feedback. For example, the user may identify a number of times that the task has been performed by the user. As another example, the user may identify a perceived skill level corresponding to the task. The user can provide any type of input that may be useful in identifying a skill level of the user and updating the profile of the user.

Another type of input that the task guidance system may utilize to modify user profiles is based upon monitoring by the task guidance system. In other words, the task guidance system can learn about a user and then update a user profile accordingly. As the user performs tasks, the task guidance system may monitor the user as the user performs the steps of the task. Monitoring the user may include using one or more sensors to detect movement of the user during performance of the task. The system can identify from the movement how quickly the user performs steps of the task, how confidently the user performs the task, parts or steps of the task that the user has problems with, how often the user refers to the instruction set when performing different steps, and/or the like. Monitoring the user may also include tracking a length of time it took a user to perform steps of the task. Indicators that indicate that the user has a higher than default skill level, or higher level of skill as compared to the current skill level of the user, can be used by the system to increase the skill level of the user. Indicators that the user has a lower skill level as compared to the current skill level of the user can be used by the system to decrease the skill level of the user. Thus, the system can monitor the user during performance of steps of a task and then update a profile of the user based upon the monitoring.

During the monitoring, the system may also identify if an unexpected step occurs that causes the performance of a task to be skewed. For example, if the user experiences an issue that was not accounted for, the system may identify that this caused the performance of the task to be extended. As an example, if a user is replacing a cable and the cable breaks so the user has to get a new cable, the system may identify the broken cable and the time that it took to replace the cable as an unexpected event. The system may mark this as an unexpected event or step so that the system can account for this in determining a skill level of the user. In other words, this unexpected event would normally cause the system to determine that the user is taking a long time to perform a step and may, therefore, need additional details to perform the step more quickly. However, by taking into account the unexpected event, the system can disregard this unexpected event time in computing a skill level of the user.

Even in the event that the system is unable to monitor the user, the system may still be able to account for some unexpected events in the skill level calculation. For example, the system may keep track of a number of times the task has been performed and a length of time or average length of time for performance of the task. If the performance of the task appears to be an outlier as compared to the length of time or average length of time, the system may disregard that task performance as far as a time for performance. However, the system may capture that task performance to be considered for a number of repetitions of the task. The system may also allow the user to provide input when an unexpected event occurs, for example, input to an icon indicating an unexpected event, a pause button, a comment or feedback section, and/or the like.

The task guidance system may also be in communication with other systems of a user or entity. These other systems may provide some information that can be used by the task guidance system to update user profiles. For example, if an entity has a training system, the task guidance system may be in communication with the training system. If a user completes a particular training that may be applicable to a task within the task guidance system, the task guidance system can receive or otherwise obtain this information and utilize it to update a skill level of the user. Thus, the task guidance system may also identify or infer a skill level based utilizing secondary sources. In addition to other applications or systems of an entity such as the training system, secondary sources may include social media posts, Internet searches, communication sources, papers or documents authored by the user, and/or the like.

The skill level of the user may be described in one or more of a variety of ways. For example, the skill level may be described on a percentage scale, a low-medium-high scale, a value scale, a star scale, a novice to expert scale, and/or the like. In other words, the skill level of the user may be described in any type of scale that identifies a skill level of a user as compared to an initial default skill level. The type of scale that is utilized may be a default scale type or chosen by a user and/or entity corresponding to the user. There may be different criteria that causes a user to move up or down the skill scale. In other words, the skill level of the user may increase or decrease based upon different criteria. The criteria may be different for different tasks, different users, different entities, and/or the like. Some criteria that may be utilized include a number of times the task was performed (i.e., a number of repetitions), a speed of performance of a task, an accuracy of performance of the task, a number of trainings completed that relate to the task, an educational background of the user, information gathered while monitoring the user performing the task, a time elapsed since the last performance of the task by the user, and/or the like.

When the skill level moves up or down within the scale may be dependent on the skill level scale, requirements by the user and/or the entity corresponding to the user, a complexity of the task, an analysis performed by the task guidance system, and/or the like. For example, the skill level may move up on the skill level scale when the user has performed the tasks a threshold or a predetermined number of times or can accurately perform the task within a threshold time limit. Since the skill level is highly configurable, the user and/or entity or characteristics of the user and/or task may mean that the skill level for different tasks moves up or down at a different rate than other tasks. For example, to move up on the skill level scale for a complex task may require more repetitions of the task than moving up on the skill level scale for a less complex task. On the other hand, moving down on a skill level scale for the complex task may take less time elapsing since last performance of the task than moving down on the skill level scale for the less complex task. Additionally, someone with a higher level of education or experience related to a particular task or task subject may move faster up the skill level scale of the particular task than a person with a lower level of education or experience.

The system may also perform an analysis of the task to assist in determining how quickly a user may move up or down the skill level scale. For example, the system may identify steps within a task and identify a complexity of the steps, a similarity of the steps to steps within other tasks that are performed by the user, how quickly a user has mastered similar tasks and/or steps within a task, how accurately a user performs a task, how frequently the user refers to an instruction set while performing a task, and/or the like. In other words, the system may perform an analysis on the task to determine how skilled the user might be at the task either before the user performs the task for the first time or as the user is performing a task. The analysis may assist in moving up or down the skill level scale more quickly or slowly based upon the abilities of the user themselves, the complexity of the task or steps within the task, requirements of the user and/or entity corresponding to the user, and/or the like.

A skill level may also be inferred based upon a similarity of a task to another task. The similarity may be identified utilizing one or more similarity identification techniques. The similarity may be based upon shared steps between tasks, a same or similar device the tasks are to be performed on, or other same or similar characteristics or features of the task. In other words, the system may compare tasks and features of tasks (e.g., steps, devices or objects the tasks is being performed on or with, etc.) to identify those portions which may be similar to each other and, in the case that one of the similar tasks has a skill level higher than a default skill level, the system may attribute this higher skill level to the other similar task. How much of the skill level is attributed to the other similar tasks may be based upon how similar the tasks are to each other, what portions or features of the tasks are similar, and/or the like. Thus, a task that is very similar to another task having a higher than default skill level will get more skill level attribution than a task that just shares a single or few similarities to the task having a higher than default skill level.

In the case of inferring a skill level, or a rate at which a user moves up or down a skill level scale for a task or similar task, the system may identify the same or similar steps across multiple tasks and then identify a skill level for those tasks, which is then taken into account for the target task. Additionally, the system may take into account the criteria for the other similar tasks or same or similar task steps and assign those same criteria to the target task or steps within the target task. As an example, if two tasks are replacing a motherboard in a particular laptop device and replacing a power plug receptacle in the same laptop device, the task guidance system may determine that the beginning steps of taking off the laptop back and removing certain components to expose the motherboard and power plug receptacle are the same. Thus, as the user performs those steps, regardless of which task the user is ultimately completing, the skill level for the other task may also increase.

In other words, because the tasks share many similar steps, the skill level for the task increases as the user performs the steps regardless of which task the user is actually performing. Since the task guidance system is able to delineate between steps of a task, the task guidance system may also, when modifying the instruction set, modify portions of the instruction set that correspond to steps having a higher than default skill level and keep other portions of the instruction set at the default skill level if the user has not increased in skill level for those steps. For example, if the user has a higher than default skill level for a task having five steps similar to another task the user has never performed, the system may assign the skill level of those similar steps to match the skill level of the steps within the higher than default skill level task. Thus, even though the user has never performed the task before, they may be presented with a modified instruction set for those steps that are similar between the two tasks.

The task guidance system may be unique to different entities that may employ the system. Thus, the task guidance system may include tasks that are relevant to the entity. For example, if one entity performs service tasks on laptop computers, the user profiles in the task guidance system for that entity may include tasks that are related to servicing laptop computers. On the other hand, if an entity performs building and servicing tasks on automobiles, the user profiles in the task guidance system for that entity may include tasks that are related to building and servicing automobiles. Further, the tasks within a user profile may be based upon a department or area corresponding to the user. For example, if the user is a technician in the automobile servicing department and specializes in servicing the engines, the tasks in that technician's user profile may be related to engine servicing tasks. How tasks are assigned to users and/or user profiles may be a default assignment, may be assigned by an entity with whom the user is associated, may be based upon trainings the user has completed, may be based upon user input, and/or the like. The tasks associated with the user and corresponding user profile may be modified or adjusted at any time by the user, another user, and/or the like.

It should be noted that the example deployment of the system that will be referenced is in the environment of a service technician who is performing service on a device. However, this is a non-limiting example as the described system can be utilized in any environment and with any user who may be performing a task utilizing an instruction set. For example, the system could be utilized by a consumer who purchased a cabinet that needs to be built by the consumer. In such a situation, the consumer may access a digital version of the instruction set and the task guidance system can identify information about the consumer using any information stored on one or more devices of the consumer, within applications of the consumer (e.g., social media, Internet browsing history, communication applications, etc.), using information provided by the user, for example, in response to a survey, and/or the like.

At 301, the task guidance system may identify a task to be performed by a user. The task guidance system may identify the task using one or more task identification techniques. One task identification technique may include the user providing input identifying the task to be performed. This may include the user selecting a particular task within a graphical user interface. For example, some technicians are required by policy to open an instruction set related to performance of a task. Thus, the user opening the instruction set, searching for a particular task and corresponding instruction set, and/or the like, can provide an identification of what task the user is going to perform. The user input may be performed using one or more input modalities, including, but not limited to, audible input, touch input, mechanical device input, gesture input, and/or the like. The user may also provide an identification of a task using other techniques. For example, the user may scan a quick-read (QR) code, barcode, or other type of identifier or code that identifies the object the task is to be performed on or the task itself.

The task may be identified by the system based upon information obtained by the system when monitoring the user. In other words, the task guidance system may identify or infer the task that a user is about to perform based upon captured information related to the user and the environment of the user. For example, the system may monitor the user and identify cues provided by the user that indicate what task the user is about to perform. As an example, the user may be talking to someone and mention what task they are about to perform. The task guidance system can parse the audio and identify the words related to the task as a task that can be performed and then infer the user is about to begin this task. As another example, the user may make a gesture, for example, reaching for a particular tool, making a gesture associated with a particular task, and/or the like, that can be used to identify those tasks which might correspond to such a gesture.

The system may also identify objects within the environment of the user, for example, an object or device within reach of the user and for which a task may be performed. Each of these objects may have associated tasks, so the task guidance system can identify those tasks which are associated with the object and infer the user is about to perform one of those tasks. The system may also identify how an object is positioned with respect to the user to assist in inferring the task. For example, if an object is positioned with the bottom side up, the system may infer that the task is one that starts with the device being bottom side up. The system may also identify the tools within reach of the user and infer what tasks can be performed using those tools, particularly in view of the object.

The task guidance system may also infer tasks based upon a combination of information obtained by the system through the monitoring. For example, the system could infer a task based upon an object within reach of the user, a positioning of the object near the user, and a gesture provided by the user. Thus, a combination of information may be utilized when inferring task identification by the system.

The system may access secondary sources when identifying tasks to be performed by the user. Depending on the environment or role of the user, the user may have secondary sources that can be utilized in identifying a task of the user. For example, within a service environment the user may have a service queue, service tickets, service schedule, and/or the like, that identifies the tasks that a user needs to perform within a particular time frame. The system can utilize this information to assist in determining a task that the user may be performing or about to perform. Other secondary sources may also be utilized and those secondary sources that are utilized or accessible may be dependent on the user, the entity corresponding to the user, the type or role of the user, the tasks that can be performed, and/or the like. Secondary sources may include, but are not limited to, user calendars, entity calendars or schedules, task queues, correspondence, and/or the like.

The system may also identify or infer the task based upon a combination of information. For example, the system may identify an object within reach of the user and identify the tasks associated with the object. The system may further filter those tasks based upon a service queue assigned to the user. If more than one task is still remaining, the task guidance system, in this example, may further filter those tasks based upon an audible cue provided by the user. It should be understood that this is merely an example of how the system could identify a task based upon a combination of information and is not intended to be a limiting example.

The information utilized to identify a task may be directly obtained by the task guidance system or may be obtained by another sensor, component, device, system, and/or the like, and then provided to the task guidance system. Thus, in identifying the task, the task guidance system can utilize information provided to the task guidance system from another system or component or the task guidance system can utilize information that is captured directly by the task guidance system.

At 302, the task guidance system may determine whether the skill level of the user with respect to the task can be determined. To determine the skill level of the user with respect to the task, the task guidance system accesses the profile of the user. The profile identifies a plurality of tasks and a skill level of the user for each of the plurality of tasks. Thus, once the task has been identified, the system can access the user profile, find the task within the user profile, and then identify the skill level associated with that task. As previously discussed, if the specific target task is not included in the user profile or the target task does not have a corresponding skill level, the system may identify a task having a similarity to the target task to identify the skill level of the user.

If, at 302, the task guidance system cannot determine a skill level of the user with respect to the task, the task guidance system may provide a default instruction set to the user at 304. A skill level of the user may not be determined if the user has never performed the task before. Additionally, the system may try to determine if the user has a higher than default skill level for a task having similarities to the task. If the system cannot identify a similar task, the system may determine that the skill level of the user cannot be determined.

On the other hand, if, at 302, the task guidance system can determine a skill level of the user with respect to the task, the task guidance system may provide an instruction set for performing the task to the user based upon the skill level of the user at 303. In other words, the task guidance system modifies or tailors the instruction set to be based upon the skill level of the user and then provides this modified instruction set to the user. The level of detail within the provided instruction set is based upon the skill level of the user. Thus, the system provides an instruction set that is modified from an initial instruction set as the skill level of the user changes. To modify the instruction set the system may utilize one or more artificial intelligence models to determine what details can be removed from the instruction set as the skill level of the user increases and what details need to be added to the instruction set as the skill level of the user decreases. The models may identify base or core instructions or details. The model(s) may also assign importance or necessary scores to other instructions or details. As the skill level changes, the model can modify the instruction set based upon the scores assigned to the instructions or details.

The system may also employ other techniques for determining what details to remove or add to the instruction set as the skill level of the user changes. For example, a user or entity may identify an order for which instructions or details are removed or added as the skill level of the user changes. As another example, the system may monitor a user and determine what details or instructions the user refers to when performing a task. The system may then remove the details that the user does not utilize when performing the task. Similarly, if the user appears to perform a step incorrectly, the system may determine this and then provide additional details for that step or otherwise reinforce the correct technique for performing the task.

The instruction set may have modified portions and unmodified portions. For example, the system may determine that the user has a higher than default skill level for certain of the steps and may modify those steps within the instruction set. However, in this same example, the system may determine that the user does not have a higher than default skill level for other steps of the task and may, therefore, not modify the default instructions for those steps. Along those same lines, different portions of the instruction set may have differing levels of details because the user may be more highly skilled in some steps of the task than other steps of the task. Additionally, the system may identify a step that the user incorrectly performs and may, therefore, provide more details for that step even though the user has met other criteria that would normally result in the removal of detail from that step. Thus, the provided instruction set is highly tailored for the user that is performing the task.

The instruction set may have any of different formats, including, but not limited to, video, audio, static images, text, gestures, a combination thereof, and/or the like. Thus, provision of the instruction set may include displaying the instruction set on a display device. However, other types of output are contemplated and possible and the output modality that is selected may be based upon the format of the instruction set, environment of the user, preferences of the user, devices accessible by the user, and/or the like. Other types of output include, but are not limited to, audio output, video output, haptic output, output on an augmented or virtual reality device, projection output, a printed output of the instruction set, combinations thereof, and/or the like. If the output device is not directly a part of the task guidance system, but rather in communication with the task guidance system, the task guidance system may generate and transmit instructions to the output device to provide the instruction set to the user. In other words, the instruction set can be provided on any output device regardless of whether the output device is a direct component of the task guidance system. This may include anything from provision of the instruction set to a device of a user or a display of the entity to provision of instructions to print the instruction set on a printer.

As an overall non-limiting example of the described system, a service technician may have a task to replace a component within a portable device. The default instruction set may include step details that indicate the portable device needs to be turned over so the bottom of the device is facing up, that a certain number of screws need to be removed using a particular type and size of screwdriver, and may also identify the location of those screws on the bottom of the device. Upon identifying the task to be performed, for example, by the user selecting the task within a graphical user interface of the task guidance system, the system identifies a skill level of the user by accessing a user profile of the user. As an example, from the user profile the system may determine the user performing this task has a high skill level. Accordingly, the task guidance system adjusts the instruction set to reflect this high skill level. In this example, the adjustments may include removing the above-mentioned details. Instead, this step within the instruction set may simply indicate that the user needs to remove the bottom cover from the device. The system modifies the entire default instruction set based upon the skill level of the user and then provides the modified instruction set to the user. Thus, the provided instruction set is tailored to the user based upon the skill level of the user.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, the method comprising:
identifying, using a task guidance system, a task to be performed by a user;
determining, using the task guidance system, a skill level of the user with respect to the task, wherein the determining comprises accessing a profile of the user identifying a plurality of tasks and a skill level of the user for each of the plurality of tasks; and
providing, to the user and using the task guidance system, an instruction set for performing the task, wherein a level of detail within the instruction set provided is based upon the skill level of the user.

2. The method of claim 1, comprising:
monitoring the user during the performance of steps the task; and
updating the profile of the user based upon the monitoring.

3. The method of claim 2, wherein the monitoring is performed utilizing at least one sensor that detects movement of the user during performance of the task.

4. The method of claim 2, wherein the monitoring comprises tracking a length of time the user took to perform the steps of the task.

5. The method of claim 1, comprising:
receiving user feedback regarding performance of the task; and
updating the profile of the user based upon the user feedback.

6. The method of claim 5, wherein the receiving user feedback comprises a user identifying a number of times the task has been performed by the user.

7. The method of claim 1, comprising updating the profile of the user based upon at least one training performed by the user for at least one of the plurality of tasks.

8. The method of claim 1, wherein the determining a skill level comprises identifying a skill level of the user for a task having a similarity to the task to be performed.

9. The method of claim 1, comprising updating the profile of the user based upon a number of times a task of the plurality of tasks has been performed and wherein the skill level is updated upon performance of the task of the plurality of tasks a predetermined number of times.

10. The method of claim 1, wherein the providing comprises providing an instruction set that is modified from an initial instruction set as the skill level of the user changes.

11. A system, the system comprising:
a processor;
a memory device that stores instructions that, when executed by the processor, causes the system to:
identify, using a task guidance system, a task to be performed by a user;
determine, using the task guidance system, a skill level of the user with respect to the task, wherein the determining comprises accessing a profile of the user identifying a plurality of tasks and a skill level of the user for each of the plurality of tasks; and
provide, to the user and using the task guidance system, an instruction set for performing the task, wherein a level of detail within the instruction set provided is based upon the skill level of the user.

12. The system of claim 11, comprising:
monitoring the user during the performance of steps the task; and
updating the profile of the user based upon the monitoring.

13. The system of claim 12, wherein the monitoring is performed utilizing at least one sensor that detects movement of the user during performance of the task.

14. The system of claim 12, wherein the monitoring comprises tracking a length of time the user took to perform the steps of the task.

15. The system of claim 11, comprising:
receiving user feedback regarding performance of the task; and
updating the profile of the user based upon the user feedback.

16. The system of claim 11, comprising updating the profile of the user based upon at least one training performed by the user for at least one of the plurality of tasks.

17. The system of claim 11, wherein the determining a skill level comprises identifying a skill level of the user for a task having a similarity to the task to be performed.

18. The system of claim 11, comprising updating the profile of the user based upon a number of times a task of the plurality of tasks has been performed and wherein the skill level is updated upon performance of the task of the plurality of tasks a predetermined number of times.

19. The system of claim 11, wherein the providing comprises providing an instruction set that is modified from an initial instruction set as the skill level of the user changes.

20. A product, the product comprising:
a computer-readable storage device that stores executable code that, when executed by a processor, causes the product to:
identify, using a task guidance system, a task to be performed by a user;
determine, using the task guidance system, a skill level of the user with respect to the task, wherein the determining comprises accessing a profile of the user identifying a plurality of tasks and a skill level of the user for each of the plurality of tasks; and
provide, to the user and using the task guidance system, an instruction set for performing the task, wherein a level of detail within the instruction set provided is based upon the skill level of the user.
